(19) United States
(12) Patent Application Publication
(10) Pub. No.: US 2026/0317596 A1
(43) Pub. Date: Oct. 15, 2026

(54) HOT-MELT ADHESIVES WITH PROPERTIES OPTIMISED FOR THE APPLICATION BY EXTRUSTION

(71) Applicant: SAVARE I.C. S.R.L., MILAN (IT)

(72) Inventors: Alberto BUGANA, Milan (IT); Italo CORZANI, Milan (IT)

(21) Appl. No.: 19/486,209

(22) PCT Filed: Jul. 3, 2024
(86) PCT No.: PCT/IB2024/056475

§ 371 Date: Nov. 20, 2025

(30) Foreign Application Priority Data
Jul. 19, 2023 (IT) 102023000015129

(51) Int. Cl. C09J 123/14; C09J 153/00

(52) U.S. Cl. CPC C09J 123/14; C09J 153/005; C09J 2400/20; C09J 2423/10; C09J 2453/00

(57) ABSTRACT

A hot-melt adhesive exhibiting excellent properties in use, such as an optimum adhesion and cohesion, and also an improved processability, that allows to apply the adhesive without any difficulty even on lines running at high speed. The hot-melt adhesive does not show in extrusion the negative phenomenon known as “die drool” or “die build-up” or “blobbing”, and other similar phenomena that cause in extrusion an uneven and inhomogeneous flow of the adhesive. The hot-melt adhesive formulations which have a rheological Relaxation Time tr, measured at 150° C., that is not lower than 0.5 ms, show, even in slot-die extrusion, an optimum processability that is completely free of any die build-up phenomenon, even under the most severe operating conditions of application lines, running at high speed.

### TECHNICAL FIELD OF THE INVENTION

The present invention relates to hot-melt adhesive formulations that, besides having excellent adhesive and cohesive properties, exhibit also an unexpected and greatly improved processability, which allows to apply them by extrusion, without any problem, even on industrial lines running at high speed (e.g. at 200 m/minute and more), both by slot-die coating and by spraying.

### BACKGROUND

As it is well known, hot-melt adhesives comprise, as their basic component(s), a thermoplastic polymer or a mixture of thermoplastic polymers, blended with various additives, like tackifiers and plasticisers. And it is also well known that, even in those cases when the polymer or the mixture of polymers constitutes only a minor fraction of the whole adhesive formulation, even lower than e.g. 50% by weight, the characteristics and properties of the polymer or of the mixture of polymers always play the most important role in determining all the main properties of the final adhesive formulation.

Moreover, it is also well known that hot-melt adhesives are processed and applied in the molten state, usually at a temperature ranging from about 130° C. to about 170° C., by substantially utilising two types of processes of application which anyhow both require an extrusion in the molten state of the adhesive:
application by spraying/fiberisation, wherein the stream of the molten adhesive is extruded through a nozzle, inside which the molten adhesive is hit by a strong jet of hot air that breaks the flow of molten adhesive into tiny particles which (depending on the geometrical conformation of the nozzle) may have different shape and size, like fibrils or droplets that can be more or less spherical or elliptical etc.
application by extrusion through a slot-die, in which the stream of the molten adhesive is extruded as a continuous film, through a generally rectangular metallic die, which has one or more horizontal rectangular slots, usually with a height of a few tenths of a millimeter and with a width of a few centimeters.

These extrusion processes, as more in general many other processes of extrusion at high temperature, are both not specific just for hot-melt adhesives, but they are commonly utilised for processing by extrusion many other thermoplastic pure polymers or polymeric mixtures also for other various final uses.

As, for example, it is explained in details in the article “Historical Review of Die-drool phenomenon during Plastics Extrusion” by J. Musil and M. Zatloukal, published in AIP (American Institute of Physics) Conference Proceedings, 1526 (16)—2013—pages from 16 to 34, some polymers and their mixtures and formulations, including also adhesive formulations, can exhibit serious problems in extrusion, especially in the extrusion by slot-die coating. These problems may make the process extremely difficult or even impossible; and in any case they severely worsen the quality and properties of the final product. For example, in the case of hot-melt adhesives, these problems in extrusion cause a significant decrease in the final adhesive strength, because they create strong unevennesses and inhomogeneities in the extruded film of hot-melt adhesive and, more in general, in the extruded film of a polymer or of a polymeric composition

In particular, the most important and most harmful issue among those problems in extrusion, that prevents the formation of a regular and homogeneous film of extruded adhesive, is the phenomenon known in industrial technology with names such as “die-drool” or “die build-up” or also “blobbing”. This phenomenon, as well explained in the above mentioned article, consists in the fact that a part of the extruded polymeric material/adhesive formulation does not create a regular film, coated on the substrate. On the contrary a part of the extruded adhesive tends to remain adhered to the metallic material of the extrusion die and it is more and more accumulating on it over time, forming masses of increasing weight and volume around the extrusion slots.

Said masses of accumulated material, which in the meantime also thermally degrade because of the persistent high temperature, now and then detach from the die at irregular intervals of time, setting down on the substrate in a fully uneven way, after which detachment the accumulation phenomenon restarts. In this way, the quality of the final product is irreparably spoiled, often at an unacceptable level, by this substantially chaotic and uncontrollable phenomenon, because both of the fully inhomogeneous thickness of the coated adhesive film and the presence on the substrate, at irregular distances, of big lumps of hot-melt formulation, lumps which are moreover strongly thermally degraded.

The Prior Art has tried to solve this serious problem of “die drool” or “die build-up” or “blobbing” in various ways, all of which however are never fully acceptable.

For instance, the Patent Applications US 2021/0115303 e US 2022/0135845 are both, first of all, highlighting the fact that the “die build-up” or “blobbing” phenomenon on the extrusion die or in its vicinity, is a problem of very high severity, with many very negative consequences, mainly in processing hot-melt adhesives by slot-die coating; and that this harmful phenomenon may appear very quickly, just within a few minutes, or even less, from the starting of the extrusion, in particular on industrial lines running at high speed, such as 200 m/minute or more, as e.g. are the industrial lines used to manufacture hygienic absorbent articles. These two Applications claim to be able to solve the “blobbing” problem in the extrusion of hot-melt adhesive by a peculiar way of formulating such adhesives; more precisely by making their formulation comprise a mixture of polymers characterised in that they have specific values of their “Peak Molecular Weight” Mp. As it is known, this value of Mp is defined as the “mode” of the distribution of molecular weights of a certain polymer or also as the molecular weight corresponding to the highest peak in the graphical representation of the distribution of molecular weights of said polymer.

More specifically, US 2021/0115303 claims to be able to solve this problem of “blobbing”/“die build-up” in slot-die coating/extrusion even on high speed lines, by formulating hot-melt adhesives in such a way that they comprise a mixture of at least three polymers, whose peak molecular weights Mp fall into three well defined ranges: a first polymer with Mp lower than 40,000 g/mole; a second polymer with Mp greater than 40,000 g/mole; and a third polymer with Mp in the range from 70,000 g/mole to 700,000 g/mole.

In a similar way, US 2022/0135845 claims to be able to avoid said greatly negative phenomenon in extrusion, by still formulating a hot-melt adhesive composition that comprises three polymers: in this case the first polymer is a metallocenic polymer having Mp lower than 130,000 g/mole; the second polymer is a polyolefin with Mp in the range from 130,000 g/mole to 700,000 g/mole; and the third polymer is an amorphous polyolefin having an Enthalpy of Crystallisation of less than 10 J/g.

Even not considering the fact that, by following the teachings both of US 2021/0115303 and of US 2022/0135845, one should be obliged to invariably formulate hot-melt adhesives always comprising at least three different polymers, which fact certainly makes more complex the manufacture of such adhesives, it is furthermore evident that it is a priori rather questionable and uncertain to strictly connect, in an exclusive and biunique relationship, a very complex rheological behaviour of the polymeric mixture, like the one that causes the presence or the absence of the “build-up” phenomenon in extrusion (a phenomenon to which are certainly contributing many different parameters, mainly rheological ones, of the extruded material) with just one parameter for each of the present polymers, like their peak molecular weights Mp, as well as their combinations.

Said in other words, it is certainly true that the molecular weight of a certain polymer (defined as Mp or also as anyone of the other several “average molecular weights” that are commonly defined for a polymer) can affect many properties of the polymer itself and of its mixtures. However, it seems rather oversimplified to think that the molecular weight alone and its combinations can have a general and exclusive impact on the fact that, in extrusion, such a complex rheological phenomenon, like the “build-up”, may appear or not depending just on the molecular weights' values. This seems even more reasonable also remembering that, as already said, this is a very complex rheological phenomenon to which are certainly contributing many other parameters and on which—as it is well known by any person with an average knowledge in Rheology—the molecular weight may have an impact that is probably important, but for sure not exclusive. For example, various studies support the theory that a substantial contribution to the die build-up phenomenon may be given by a too strong alignment, at the moment of extrusion under the applied elongation stress inside the extrusion die, of the molecular chains of the polymer, which may lead to a “premature crystallisation”, even if the polymer is formally still over its melting temperature; and certainly this phenomenon is not related at all with the molecular weight of the tested polymer.

In fact, as the inventors of the present invention have experimentally checked, the criteria used for the selection and the combination of Mp's claimed both by US 2021/0115303 and by US 2022/0135845 actually are not working, not only in general terms, but also in a few specific examples shown in those patent applications.

It seems reasonable to think that a better predictability of the fact whether the very harmful rheological phenomenon known as “die build-up” may happen or not, can be achieved by utilising, instead of the molecular weight alone and of its combinations, other rheological parameters which per se are implicitly containing the combination of many other characteristics and parameters related to the behaviour in extrusion of a polymer or of a mixture of polymers, and not only the length/weight of their molecular chains. For example, WO 2023007257 describes a peculiar and unusual rheological experiment, named “Induced crystallisation under shear-stress” that is performed on the polymer or on the mixture of polymers which constitutes the polymeric fraction of a certain hot-melt adhesive formulation. This patent application claims the fact that, according to the result of said experiment, that is involving peculiar rheological parameters of said polymers, it is possible to certainly predict whether the hot-melt adhesives comprising said polymer or mixture of polymers, show or do not show “build-up” when they are processed by extrusion. In particular, the very peculiar above mentioned rheological experiment, described in WO 2023007257, measures the speed at which the Elastic Modulus G′ of the polymer or of the mixture of polymers is increasing, at a certain constant temperature and after the application of a fixed shear-stress, compared with the speed at which the Elastic Modulus G′ of the same polymer or mixture of polymers is increasing at the same temperature, but without the application of any shear-stress. It is the case to notice that, as prescribed by WO 2023007257, this rather unusual rheological text, for predicting the possible presence in extrusion of a build-up phenomenon, is carried out at a reference temperature equal to 80° C. The use of this reference temperature is justified by asserting that this temperature represents the average temperature at which an extruded hot-melt adhesive formulation is, in about the first five centimeters of distance from the extrusion die, immediately after its extrusion. While this assertion is certainly true in general terms for a majority of cases in hot-melt processing, however it is also necessary to notice that in an even larger majority of cases a reference temperature equal to 80° C. is typically also below the setting temperature of most hot-melts, as it occurs also e.g. for all the three Examples according to the invention shown by WO 2023007257 itself, which all have a Ring & Ball Softening Point well above 80° C. This means that the peculiar rheological test claimed by WO 2023007257 is carried out on a semi-solid hot melt adhesive, that actually has already overcome the “shock” that the molten material suffers in the moment itself of its extrusion (and at the temperature of that extrusion) inside and just out of the extruding die, and that may lead to a build-up phenomenon. One could therefore object that it seems more reasonable, for a test that tries to predict a possible build-up in extrusion, to choose a reference temperature that is the average one at which the extrusion of most hot-melt adhesives generally occurs, as e.g. the inventors of the present invention have done by selecting the reference temperature of 150° C. (a typical average extrusion temperature for the great majority of hot-melt adhesives) for measuring the Relaxation Time tᵣ of the various adhesives as a predictor of the presence or absence of die build-up phenomena at the moment of their extrusion, as it will be also explained below in more details.

Moreover, even admitting that the rheological method described by WO 2023007257 may have some good predictive efficacy, it is however clear that said method is not only difficult to be practically performed, but that it is also evident that most likely the efficacy and precision of said method in predicting the behavior in extrusion of a certain hot-melt formulations is strongly affected by the actual quantity/concentration of polymer(s) contained in said formulation; and that this precision significantly worsens with the decrease in absolute terms of such quantity/concentration of polymer(s). This derives from the fact that the rheological method described by WO 2023007257 is trying to predict the most probable rheological behaviour in extrusion of a certain hot-melt formulation from rheological experiments performed only on its pure polymeric fraction, that in many cases can be only a minor portion of the whole adhesive, for instance just 20% by weight and in some cases even just about 10% by weight. Therefore, it can be inferred that, even if the rheological method claimed by WO 2023007257 may be possibly effective in predicting whether the build-up phenomenon occurs or does not occur for hot-melt adhesives that contain a high amount of polymers, its practical predictive efficacy is rapidly decreasing as the fraction of polymers, contained in a certain adhesive, is gradually becoming smaller and smaller. It is thus possible to say that the rheological method disclosed by WO 2023007257 does not have a general efficacy.

Moreover, in examining what has been so far disclosed by the Prior Art about the build-up phenomenon in the extrusion of hot-melt adhesives, one can notice that some previous patents or applications, e.g. US 2019/0202188, are using the wording “build-up” in a somehow improper way. In particular, the mentioned US 2019/0202188 is describing the build-up phenomenon in the extrusion of hot-melt adhesives, as occurring on mechanical parts of an industrial line, which are not the extrusion-die for the coating of a substrate with the adhesive, like in the present invention. More precisely in US 2019/0202188 the inventors disclose a supposed “build-up” of adhesive on the rolls that are used to compress together two substrates (one of which substrates is a perforated and permeable one) after that the same substrates have been coated with the adhesive and glued to create a laminated structure. And in this case, US 2019/0202188 teaches to adjust the line operating parameters, such as the temperature of said rolls, for trying to avoid said “build-up” of adhesive on the compression rolls. However, it is fully clear that in this case the phenomenon described by US 2019/0202188, even if it is still named “build-up”, is completely different from the “die build-up” problem on the extrusion die, which is described and solved in the present invention. Indeed, in the case of US 2019/0202188, the phenomenon defined as “build-up” and solved with a simple heating of the rolls, could more properly be described as a “fouling” of said rolls and of other mechanical components of the line by the semi-molten and solidifying adhesive. This fouling is not related at all with the extrusion of said adhesive. In fact, it occurs because the already extruded semi-molten adhesive, that has been coated on the substrates, under compression of the rolls, may leach through a perforated substrate, e.g. a non-woven or another fibrous substrate, and adhere on said rolls' metal, even in positions that are well far from the extrusion die. Said fouling phenomenon, caused by a film of semi-molten adhesive, which has been already extruded and coated on perforated substrates, even in a regular shape, is, as said, a totally different phenomenon than the “die build-up” described and solved in the present invention and which is completely unrelated to it. Indeed, the die build-up phenomenon described herein is a fully chaotic event which occurs exclusively on the extrusion die and during the extrusion itself, and that causes, as said, strong unevennesses and inhomogeneities in the thickness and coated area of the film of extruded adhesive when it is coated on any type of substrates, both perforated and not perforated ones.

Summarising, the Prior Art has been unable so far to offer a solution, which is valid in general terms and also easy to be utilised, to the important problem that is met by all the formulators of hot-melt adhesives, i.e. the problem of formulating said adhesives in such a way that, when they are processed by extrusion even on lines running at high speed like 200 m/minute and more, they do not exhibit the very harmful rheological phenomenon named “die build-up” and other similar phenomena that lead to a very irregular and inhomogeneous flow in extrusion. Therefore, in the industry there is still the need to find a reliable method for accurately predicting and avoiding, during the formulation of hot-melt adhesives, this very negative rheological phenomenon; as well as there is still the need that this capability of prediction is based on few and simple rheological parameters of the adhesive itself, parameters that ideally are available or anyhow are easily measurable with simple experiments that are already widely known by any person who has even just an average knowledge in the field of hot-melt adhesives and of their Rheology.

### SUMMARY OF THE INVENTION

The problem that the present invention aims at solving is to teach how to formulate hot-melt adhesives that do not exhibit during extrusion, and especially in slot-die coating, the highly negative phenomenon known as “die drool” or “die build-up” or also “blobbing”, and other similar phenomena that cause a very irregular and inhomogeneous flow in extrusion.

On the contrary, the hot-melt adhesives according to the present invention exhibit an optimum and improved processability, even on industrial lines running at high speed, like 200 m/minute and more, although utilising standard slot-dies and without modifying too much the basic parameters of the process, like the temperature of the extrusion tool. In this way, the temperature can be kept at its optimum value, typical of a certain hot-melt adhesive, without causing further problems ensuing from its variation; like e.g. damages of thermo-sensitive substrates, in the case that the temperature is increased too much, or possible issues in extrusion due to a too high viscosity, if on the contrary the temperature is decreased.

The inventors of the present invention have surprisingly found that this highly improved processability in extrusion, that in particular fully avoids all die build-up phenomena and other similar phenomena of irregular and inhomogeneous extrusion, is achieved by formulating the hot-melt adhesive composition in such a way that one of its rheological parameters, i.e. its rheological Relaxation Time at 150° C., a parameter which is widely known by any person who has an average expertise in the field of hot-melt adhesives and of their Rheology, and which is often indicated with the symbol tᵣ, is not lower than 0.5 ms. Said rheological parameter can be easily measured for every hot-melt adhesive formulation by the simple method which is described in detail below.

For further clarity, we can here recall that all thermoplastic polymeric systems, including hot-melt adhesives, in general show in the molten state a viscoelastic behaviour. And it is also widely known by any person with an average knowledge in the field of the Rheology of polymers and of their compositions, that the rheological Relaxation Time tᵣ is a parameter which is characteristic of any polymer and of any polymeric composition, like hot-melt formulations. More specifically, this rheological parameter is defined as the characteristic time with which a certain polymer or polymeric composition is able to dissipate (e.g. through internal molecular frictions and the generation of heat) the energy that it has received from an external force, in this way returning to its primitive equilibrium state. Said fundamental and well known rheological parameter is clearly defined and explained e.g. in the book “Principles of Polymer Processing” by Z. Tadmor and C. G. Gogos in chapter 2—page 40 and in the book “Physical Properties of Polymers” by J. E. Mark et alii, in chapter 3, page 105 and in the following pages.

For the purposes of the present invention, the rheological Relaxation Time of the hot-melt adhesive formulations disclosed herein is, as said, expressed in seconds (s) and is measured, according to the method described below, at the reference temperature of 150° C. The choice of this reference temperature for the rheological Relaxation Time of the present thermoplastic adhesives has been suggested by the following considerations: the operating range of temperatures for the extrusion die most frequently used on industrial lines that process hot-melt adhesives, usually ranges from about 130° C. to about 170° C. This fact suggested to choose and set at the average value of 150° C. the temperature at which all the hot-melt adhesives of the Examples illustrated later (which may exhibit or not a “die build-up” phenomenon in extrusion) have been processed and extruded. Therefore, this temperature value of 150° C. has been kept as the average reference temperature at which all the main rheological parameters of the hot-melt adhesives disclosed and exemplified herein have been measured, and especially for the measurement of their rheological Relaxation Time tᵣ.

Besides said specific values of their rheological Relaxation Time, the hot-melt adhesive formulations disclosed herein exhibit also an optimum adhesive strength, expressed e.g. by a Peel Strength, measured according to the method described below, that is not lower than 1.0 N/50 mm at the very low basis weight of just 1.5 g/m². This excellent adhesive strength is not only an essential requirement for any good adhesive, but, in a certain sense, it is also an indirect evidence that the extrusion of the present adhesives on a substrate has occurred without any “die build-up”, in a way that is as much as possible smooth. Indeed, as already mentioned, the first negative consequence of a “die build-up” phenomenon, in the processing by extrusion of a hot-melt adhesive, is an unacceptable decrease of the overall observed adhesive strength. Indeed, as already described, in the presence of die build-up, the film of adhesive, extruded on the substrate, is grossly uneven and inhomogeneous, with areas where the adhesive is present in very low amounts or is fully absent, and, on the contrary, areas where rare big lumps of adhesive are gathering, usually already heavily degraded for their prolonged residence at high temperature on the hot metal of the extrusion die.

The inventors of the present invention have furthermore discovered that, at least in the case of hot-melt adhesives “at high viscosity” (as this attribute is defined below, i.e. for adhesives showing a Brookfield viscosity at 150° C., conventionally not lower than 3,500 mPa·s), it is preferable that the hot-melt formulations which have a rheological Relaxation Time tᵣ, measured at 150° C., not lower than 0.5 ms, and which therefore do not exhibit any die build-up in extrusion, have also a Zero Shear Viscosity Eta₀, also measured at the reference temperature of 150° C., that is not lower than 4,000 mPa·s. This further requirement for said additional rheological parameter, which is better defined below, seems to help in avoiding any die build-up phenomenon, especially for highly viscous formulations which, owing to their obviously “more difficult flow” in extrusion due to their high viscosity, may more likely adhere on the outside metallic surface of the slot-die and start a build-up phenomenon. Without being linked to any specific theory, it seems reasonable to think that such helping effect on the absence of any build-up, for an extruded molten material that has a sufficiently high viscosity even in conditions of zero applied shear stress (e.g. just outside the extrusion die's slots) can be explained in the following way. As already mentioned, various studies about the die build-up phenomenon in extrusion support the theory that a substantial contribution to this negative behaviour of the molten polymeric material may be given by a too strong alignment, at the moment of extrusion under the elongation stress applied inside the extrusion die, of the molecular chains of the polymer, which may lead to a “premature crystallisation” even if the polymer is formally still over its melting temperature. This may cause a significant “hardening” of the extruded polymeric material, even if it is still formally “molten”, and may further impair its flow and help therefore the adhesion of such material on the outside metallic surface of the die, where the material is no more under any shear stress, in this way facilitating the starting of a die-build up. On the contrary if the molten material is sufficiently viscous (and its “limit viscosity” is given just by its Zero Shear Viscosity Eta₀ as explained better later) this alignment and “premature crystallisation” due to the applied elongation stress inside the extrusion die, is made more difficult because the mobility of the polymeric chains is strongly hindered by the viscosity itself, even at the lowest shear stresses and, to the limit, even at zero shear stress.

However, the facility with which the polymeric chains may be aligned under the shear stress inside the extrusion-die and may produce a “premature crystallisation” even in the still molten state, depends certainly on many other parameters of the polymeric material, besides the system's melt viscosity. E.g. it depends certainly on the structure of these polymeric chains, in the sense that, at a certain viscosity of the molten system, structurally linear and regular polymeric chains can be certainly aligned (and therefore produce this very negative premature crystallisation) much more easily than highly branched polymeric chains. Therefore, the additional and optional requirement of having a Zero Shear Viscosity Eta₀ at the Reference Temperature of 150° C. (as defined below) which is not not too low and preferably not lower than 4,000 mPa·s, may only help in avoiding die build-up phenomena especially for highly viscous systems which comprise polymers with very linear and regular chain structures.

In any case, the problem that the present invention aims at solving can be considered certainly solved in an optimum and unexpectedly effective way by hot-melt adhesives which exhibits the characteristics of claim 1) and of the claims from 2) to 23); by a bonded structure which exhibits the characteristics of claim 24); and by an article which shows the characteristics of claims from 25) to 32). The other sub-claims disclose preferred embodiments.

### Definitions

The expressions “comprising” or “that comprise(s)” are used herein as open-ended terms, that specify the presence of what follows said terms in the text, but that do not preclude the presence of other ingredients or features, e.g. components, elements, steps, either known in the art or disclosed herein.

The expression “polymer(s)” is used herein according to the definition given in the document issued by ECHA—European Chemical Agency—edition of December 2017—and titled “How to decide whether a substance is a polymer or not and how to proceed with the relevant registration”. Hence, in the present invention we define as a “polymer” any chemical substance that contains more than 50% by weight of “polymeric molecules”; where said “polymeric molecules” are in turn defined as those molecules that contain at least three base units (monomeric ones or more complex) that are bound to a fourth unit, that can be equal or different from the first three units. Therefore, said polymeric molecules contain in total at least four base units, that can be monomeric units or more complex ones (when e.g. the base unit is, in its turn, composed by two or more monomers as it happens in condensation polymers). The expression “polymer(s)” comprises therefore both polymeric molecules formed by just one type of base units/monomer (homopolymer) as well as by multiple different types (copolymer).

In a similar way, the expression “oligomer(s)” means herein a chemical substance that contains more than 50% by weight of “oligomeric molecules”; where said “oligomeric molecules” contain less than three base units (monomeric ones or more complex) bound to another unit that can be equal or different from the first three units. Also the expression “oligomer(s)” comprises both oligomeric molecules formed by just one type of base units/monomer (homo-oligomer) as well as by multiple different types (co-oligomer).

More specifically, the expression “homopolymer(s)” is used herein according to the definition given by IUPAC (International Union of Pure and Applied Chemistry) in the article “Glossary of Basic Terms in Polymer Science”, published in “Pure and Applied Chemistry”, Vol. 68, No. 12, pp. 2287-231 1, 1996. Therefore, the expression “homopolymer(s)” means herein a polymer that is synthesised from just one type of monomer. Still according to the same reference, the expression “copolymer(s)” means in the present invention (unless it is specifically indicated a different meaning) not only a polymer in the chemical composition of which two different monomers are used, but also polymers in the chemical composition of which three, four, five or more different monomers are used. According to the above-mentioned reference, when one wants to emphasize the number of different comonomers that constitute a certain copolymer, one can also use, as an alternative, the expressions “bipolymer”, “terpolymer”, “quaterpolymer” and so on.

The expressions “that is (are) not solid” are used herein to mean that a specific compound or material or ingredient or their blends, are in a physical state in which, even if they have a well definite volume, they do not have a fixed own shape, and they take the shape of the containers that contain them. Even in the case that they are sufficiently viscous to be temporarily shaped by themselves in any tridimensional shape, after being left at rest and without any external stress, apart from their own weight, they spontaneously flow and permanently deform, so to lose rather quickly (typically in a period of time that may vary between a few seconds and about one day) their initial shape, taking the shape of the containers that contain them (if these ones were not already full to the brim) or of the solid surface on which they are lying. Therefore, this definition comprises all the materials that not only may be defined as “liquid” (both at high and low viscosity) according to the common meaning of this adjective, but also all those materials that, in the common language, are for example defined as “creamy”, “pasty”, “jelly-like”, “fluid”, “greasy”, “semi-solid” and the like.

The equivalent expressions “First Temperature of the Crossing of the Moduli” or “Rheological Setting Point” or “Temperature of Rheological Setting” and its symbol Tx, mean, in a rheological diagram in which they are measured, as a function of temperature, the Viscous Modulus G″, the Elastic Modulus G′ and their ratio Tan Delta, the highest temperature at which the two Moduli cross (and in which therefore the value of Tan Delta is equal to 1) in the range of temperatures above room temperature (23° C.). Said rheological diagram, when measured in decreasing temperature, with a sufficiently slow cooling rate (e.g. 3° C./minute, as done herein), mimics very well the phenomena that occur between the adhesive and a substrate in the real process of the application of a hot-melt adhesive from the molten state and of the subsequent creation of the adhesive bond, during the slow spontaneous cooling and setting/solidification. The “Rheological Setting Point” Tx identifies, in particular, the temperature at which the hot-melt adhesive, when applied in the molten state on a substrate, starts to form the final adhesive bond in the solid state.

The expression “Crossover Modulus” and its symbol Gc mean, again in the above mentioned rheological diagram, the absolute value (that by definition is identical), expressed in Pa or in MPa, that the Elastic Modulus and the Viscous Modulus have at the “Rheological Setting Point” Tx.

The Dynamic Viscosity of a molten or liquid material at a certain temperature is expressed in mPa·s and it is measured according to the Method ASTM D 3236-88 (2014). In particular, this Method teaches to measure the parameter that, in the technology of hot-melt adhesives, is generally referred to as the “Brookfield viscosity” of the adhesive.

The Enthalpy of Fusion, Enthalpy of Crystallisation and the Glass Transition Temperature of a certain material are herein measured by Differential Scanning Calorimetry (DSC). All these DSC measurements, both in crystallisation cycles, i.e. in decreasing temperature, and in fusion cycles, i.e. in increasing temperature, are herein performed according to the method ASTM D 3417-99. Said cycles are performed between +180° C. and −70° C. (or vice versa), with a rate of change of temperature (both in increasing and decreasing temperature) that is equal to 10° C./minute.

When the DSC Fusion or Crystallisation diagram of a certain material shows two or more peaks (even partially overlapped) the Peak Temperature of the peak which has the largest area, and hence the greatest Enthalpy is defined herein as “Temperature of the Fusion Peak” for the material or “Temperature of the Crystallisation Peak” of the material. The overall value of the Fusion Enthalpy or of the Crystallisation Enthalpy is calculated as the sum of all the peaks of fusion or of crystallisation which have been detected by DSC. The Enthalpies of Crystallisation and of Fusion are expressed in J/g and are given by the area (calculated by integration) of the peak or by the sum of the areas of the peaks detected during the DSC cycles.

The Molecular Weights of polymers and their different average values (Mw, Mn, etc) well known in Macromolecular Science, are measured herein by Gel Permeation Chromatography (GPC).

“Room temperature”, if not specifically defined in a different way, means a temperature equal to 23° C.; and “room conditions” means the conditions of an environment at a controlled temperature and relative humidity, equal to 23° C. and 50% relative humidity.

Unless differently specified, all rheological parameters measured for the present invention, e.g. the Elastic Modulus G′ of a material, are measured at the frequency of 1 Hz, in a rheological test in decreasing temperature, between 170° C. and −20° C., at a decreasing rate for the temperature equal to 3° C./minute.

Because a few polymeric materials, used in the present invention, change some of their properties (e.g. the quantity and morphology of their crystalline fraction, and hence their Enthalpies of Fusion and their mechanical properties) as a function of the time elapsed from the moment of their solidification from the molten state, in the present invention we distinguish said properties that can change with time, between “Properties at Time Zero” and “Aged Properties” at a certain number of hours or days of aging (typically five days) after the material's solidification from the molten state.

Therefore a certain property “at Time Zero” (for example, an Elastic Modulus G′ at Time Zero), that may also be called as an “initial” property, or a property “in the initial conditions”, means that said property is measured at 23° C. (unless a different temperature is specifically indicated) and at 50% relative humidity, and at a time that is not longer than 120 minutes from the solidification of the material under test from the molten state.

On the contrary, a certain property that is e.g. “aged at five days” or “at five days” or “in aged conditions”, means that said property is measured at 23° C. (unless a different temperature is specifically indicated) and at 50% relative humidity, after five days from the solidification from the molten state of the material under test. During these five days of aging the material under test is kept in a climatic room, at 23° C. and 50% relative humidity.

The “Tensile Properties” or “Mechanical Properties in Tension” of all the materials disclosed herein, e.g. the hot-melt formulations, like the so called “Stress—Strain Curve”, and the respective “Peak Stress” or “Ultimate Tensile Strength”; the “Stress at Break”; and “Elongation at Break” etc., are herein measured at 23° C. and 50% Relative Humidity (unless a different temperature is specifically indicated), according to the below described method. In particular, in a Stress-Elongation curve of a certain material, the Yield Stress is defined as the stress at the Yield Point. This is in turn identified as that point in the curve in which the material ceases to have an “elastic” behaviour (i.e. ceases to have a behaviour in which the Elongation is directly proportional to the applied stress) and starts to have a “plastic” deformation. Practically the Yield Point coincides with the point where the Stress—Elongation curve ceases to have a straight linear shape and starts to bend, assuming a curved shape.

The Toughness of a certain material is numerically expressed by the whole area under the Stress—Elongation curve, calculated by integration. It measures the specific energy that is required to mechanically break a certain material and it is expressed in MJ/m³.

The rheological and tensile properties as well as the curve Stress—Elongation are herein measured with a rotational Rheometer Ares G2, supplied by TA Instruments. For measuring the tensile properties and for determining the curve Stress-Elongation, said rheometer is equipped with an accessory tool called Extensional Viscosity Fixture (EVF). The rheometer is equipped also with a controlled temperature space (FCO) that allows to perform tests at a controlled and fixed temperature between −50° C. and +250° C.

In the test for obtaining the curve Stress—Elongation, the tested material is extruded, by a lab-coater for hot melt adhesives, at the temperature of 160° C., on silicone paper as a continuous strip having a width of 50 mm and a thickness of 0.2 mm. The extruded adhesive is aged for five days in a climatic room at 23° C. and 50% relative humidity before performing the test. After five days of aging, the samples for the test, with a length of 100 mm each are cut from this continuous strip of aged adhesive. Said samples are tested by using the EVF tool at the temperature of 23° C. (or at a different temperature, as specified) and at the rotation frequency of the extension-roll equal to 0.01 turn/s, i.e. at the frequency of 0.01 Hz.

The substantive “compatibility” and the adjective “compatible”, referred to the mutual blends of the ingredients of the present hot-melt adhesive formulations, and in particular to the blends of two or more polymers, are herein considered in the meaning defined in the “IUPAC. Compendium of Chemical Terminology”—2nd Edition—1997. I.e. a blend is “compatible” when it shows macroscopically uniform physical properties, independently of the fact that it is formed by “miscible” blends (i.e. that show just one Glass Transition Temperature, Tg) or by “immiscible” blends (i.e. with two or more Tg's). In particular, the present invention considers as “compatible” all those blends that, when kept in the molten state at 170° C. for 72 hours, do not exhibit any visual de-mixing in two or more layers/phases.

“Polydispersity Index” or “Molecular Weights Distribution Index” or “PDI” refers to a measure of the distribution of the molecular weights in a certain polymer. It is defined as the ratio between the Weight Average Molecular Weight Mw, and the Number Average Molecular Weight Mn: PDI=Mw/Mn. Greater values of PDI correspond to broader distribution curves of molecular weights and vice versa. Even for compatible blends of polymers it is possible to define an average Mw, an average Mn and therefore a global “Index of Polydispersity” as defined in the case of single polymers. Mw, Mn and their ratio Mw/Mn=PDI, are measured by Gel Permeation Chromatography (GPC).

“Open Time” of an adhesive refers, especially for a hot-melt adhesive, to the interval of time during which, after its application from the melt on a first substrate, the adhesive is able to form sufficiently strong adhesive bonds for the intended use, with a second substrate that is brought into contact under moderate pressure with the first one. It is evident that too short open times may make difficult-to-manage the application of an adhesive and the formation of sufficiently strong bonds. The open time of a holt-melt adhesive may be measured according to the test method ASTM D 4497-94, under the following conditions for the hot-melt adhesives disclosed herein:
Coating temperature of the adhesive film: 170° C.
Thickness of the adhesive film: 1 mm

“Ring & Ball Softening Point” or “Ring & Ball Softening Temperature” refer to the softening temperature of a material, measured according to the Method ASTM D 36-95. Just for waxes, the Softening Point (known in this case also as “Dropping Point” or as “Drop Melt Point”) is measured according to the Method ASTM D 3954-94.

The overall Adhesive Strength or “Peel Strength” is defined as the average strength per unit of width needed to separate two substrates, bonded by the adhesive under test. It is measured through a separation test made at a controlled and constant speed, and under a controlled and constant de-bonding angle. It is herein measured according to the Method ASTM D 1876-01, separating the two substrates under a de-bonding angle of 180 degrees, by applying a separation speed of the two substrates equal to 150 mm/minute, that means that the testing dynamometer is actually moving at a speed of 300 mm/minute. The two substrates used herein are a polyethylene film, with a basis weight of 15 g/m², supplied by Poligof (Italy), that is glued to a polypropylene non-woven with a basis weight of 12 g/m², supplied by Union Industries (Italy). The adhesive under test is melted at 150° C. and it is then applied by slot-die coating on the non-woven substrate at a basis weight of 1.5 g/m² and immediately put into contact and adhered with the polyethylene film. The bonded laminates are then aged for five days in a climatic room kept at 23° C. and 50% relative humidity. At the end of such aging, the samples are tested for their Peel Strength. This measurement is made by recording the strength needed for separating the two glued substrates on a width of 50 mm, according to the recommendations of the above mentioned ASTM method, and working at 23° C. and 50% relative humidity.

The expression “Hygienic absorbent articles” refers to devices and/or methods concerning disposable absorbing and non-absorbing articles, that comprise diapers and undergarments for incontinent adults, baby diapers and bibs, training pants, infant and toddler care wipes, feminine catamenial pads, interlabial pads, panty liners, pessaries, sanitary napkins, tampons and tampon applicators, wound dressing products, absorbent care mats, detergent wipes, and the like.

The Zero Shear Viscosity of a polymeric system, as already mentioned, is herein expressed in mPa·s and it is measured, according to the method described below, at the reference temperature of 150° C., for the reasons that have been already explained. This rheological parameter is also indicated with the symbol Eta₀. As well known to any person with an average knowledge in the Rheology of polymers and of their blends and formulations, polymeric systems have, in their molten state or in solution, a behaviour which is strongly viscoelastic/non-newtonian. In particular, the great majority of these systems exhibit a pseudo-plastic behaviour, i.e. their apparent viscosity at a certain temperature decreases with the increase of an applied shear stress. Therefore, their “Zero Shear Viscosity” is herein defined as the constant asymptotic value (plateau) to which the viscosity of a liquid polymeric system tends at a certain constant temperature, both in the case of molten polymers/polymeric formulations as well as of polymers or of polymeric formulations in solution, when the applied Shear Stress or the Shear Rate of the applied stress tend to Zero, in an experimental curve that relates the apparent viscosity of the liquid system with the applied Shear Stress or with its Shear Rate. The Zero Shear Viscosity Eta₀ of a polymeric system is also clearly defined and explained, for example, in the book “Polymer and composite Rheology” by R. K. Gupta in Chapter 3—page 37, and in the book “Polymer Physics” by U. W. Gedde—Chapter 6—pages 101 and 102.

For the purposes of the present invention, the Zero Shear Viscosity Eta₀ of the hot-melt adhesives disclosed herein, or of their related polymers, is measured according to the following method: the hot-melt adhesive formulation under test is placed between two parallel plates, with a diameter of 25 mm, of a Rheometer Ares—G2 supplied by TA Instruments, equipped with an ECT oven for heating the sample, and with a cooling system suitable for rapid cooling. The material is heated and melted at 180° C. Then it is conditioned at this temperature for 300 s, applying during all this conditioning period a shear rate equal to 1 s(−1). This initial heating up to the temperature of 180° C. and the following conditioning at said temperature for 300 s, are aimed at deleting the possible memory of the “thermal history” of the sample, by bringing the material into its fully amorphous form, destroying all the crystals that may have formed during the previous thermal treatments. In this way every material undergoing the test has the same “thermal history” as all the other samples. When the conditioning step ends, the material is analysed in a way that allows to measure its Zero Shear Viscosity at the reference temperature of 150° C. For this measurement method, like for all the parameters, equations and methods of Polymer Rheology used herein, and especially for the concept of the “Time-Temperature Superposition Principle” or TTS; for the Williams-Landel-Ferry (WLF) equation; for the concept of “Master Curve at a certain reference temperature”, here reference is made to the book by John D. Ferry “Viscoelastic properties of polymers” (3d ed.—1980). New York: Wiley and to the article by John D. Ferry and H. S. Myers “Viscoelastic properties of polymers” published in Journal of The Electrochemical Society, 2007, 108(7), 142C. More specifically, in this test the tested polymeric material/adhesive formulation undergoes a series of Frequency Sweeps in a range of frequencies from 0.01 rad/s to 200 rad/s (i.e. from 1.6.EXP(−3) Hz to 31.83 Hz) and in a range of temperatures from 70° C. to 210° C., at intervals of 10° C. between the various sweeps. As taught by the above mentioned references, these experiments are made by applying in each test a “suitable” percent deformation, that changes with temperature and that is in any case such that every test is done within the area of linear viscoelasticity (LVE). As it is widely known by every person with an average expertise in the rheology of polymeric systems, and as it is well explained in the above mentioned references, this series of rheological experiments is aimed at drawing the Master Curve of the Viscosity versus Frequency/Shear rate of the applied stress, at the reference temperature of 150° C., by applying the so called “Time-Temperature Superposition Principle” or TTS. In this case, said Master Curve shows, as said, the apparent viscosity of the material, as a function of the frequency of the applied Shear Stress in an extremely large range of frequencies, that in this specific case go from da 1.EXP(−6) rad/s to 1,000 rad/s (i.e. from 1.6.EXP(−7) Hz to 159 Hz). According to its definition, in such diagram the Zero Shear Viscosity is identified as the asymptotic value (plateau) to which the viscosity tends, in the field of the lowest frequencies, as the frequency of the applied Shear Stress tends to zero.

In the context of the present invention, the expressions “high viscosity” or “at high viscosity” mean in particular hot-melt formulations or related polymers or blends of polymers that have a Brookfield viscosity, measured at 150° C. according to the Method ASTM D 3236-88 (2014), which is not lower than 3,500 mPa·s.

Other less usual parameters, measured according to specific methods, will be defined later, together with the detailed description of their measurement methods.

### DETAILED DESCRIPTION OF THE PREFERRED EMBODIMENTS AND OF THE MAIN COMPONENTS AND PROPERTIES OF THE HOT MELT ADHESIVES ACCORDING TO THE PRESENT INVENTION

The hot-melt adhesive formulations according to the present invention have an optimum and strongly improved processability compared to the present status of the art. In particular, they can be easily processed and applied by a slot-die extrusion coating process, even at high or very high line speed, e.g. 200 m/minute and more, without showing the very harmful phenomenon known with the names of “die drool” or “die build-up” or also “blobbing”.

This surprising and very beneficial property is obtained by formulating the present hot-melt adhesive formulations according to the criteria and by using the raw materials that are presented below.

Notably, the hot-melt adhesive formulations according to the present invention exhibit:
a rheological Relaxation Time tᵣ not lower than 0.5 ms, when measured at 150° C. according to the herein described method;
a Brookfield viscosity at 150° C. ranging from 500 mPa·s to 150,000 mPa·s.

The present hot-melt adhesive formulations comprise, as their fundamental component, from 5% by weight to 100% by weight, and preferably from 10% by weight to 95% by weight, of a polymer (which can be either a homopolymer or a copolymer) or of a mixture of two or more polymers (which individually can be both homopolymers or copolymers) and which are mutually compatible.

### Other Components of the Hot.Melt Adhesives According to the Present Invention

### Tackifiers

In an embodiment of the present invention, the hot-melt adhesive formulations that are disclosed herein also comprise at least one tackifying resin, which has a Ring & Ball softening temperature ranging from 5° C. to 160° C.

In general, the tackifiers comprised in the hot-melt formulations of the present invention can be selected from aliphatic hydrocarbon resins and their partially or totally hydrogenated derivatives; aromatic hydrocarbon resins and their partially or totally hydrogenated derivatives; aliphatic-aromatic hydrocarbon resins and their partially or totally hydrogenated derivatives; polyterpene and modified terpene resins and their partially or totally hydrogenated derivatives; rosins (colophonies), their esters and their partially or totally hydrogenated derivatives; and mixtures thereof. It has been moreover discovered that it is preferable that the tackifying resins used in the hot-melt adhesives of the present invention have a Ring & Ball softening temperature ranging from 50° C. to 155° C.

Particularly preferred are those tackifying resins that are highly purified and which contain an extremely low quantity of impurities and of volatile monomeric compounds, such as xylene, toluene, hexene, vinyl-toluene, indene etc., monomers that contribute to the generation of malodours in the finished product and to the decrease of the tackifier's thermal stability. Said volatile compounds are analysed and quantified by ionic Gas-chromatography with head-space, by heating a sample of 2 g of the tested tackifier for 30 minutes at 190° C. and with a head-space of 20 ml. In the present invention, tackifying resins which contain a quantity of volatile compounds not greater than 5 ppm (parts per million), preferably not greater than 2 ppm and even more preferably not greater than 1 ppm are particularly preferred. Industrial examples of similar tackifying resins at a very low level of volatile impurities, are the tackifiers sold by Synthomer (USA) under the trade mark UltraPure.

In the embodiment of the present invention where the herein disclosed hot-melt adhesive formulations comprise at least one tackifying resin or a mixture of tackifying resins, they comprise from zero to 75% by weight of at least one tackifying resin or of a mixture of tackifying resins, preferably from 10% by weight to 70% by weight and more preferably from 20% by weight to 65% by weight, referred to the whole hot-melt adhesive formulation.

### Plasticisers

In another embodiment of the present invention, the present hot-melt adhesive formulations comprise also at least one plasticiser which is not solid at room temperature, i.e. at the temperature of 23° C., or of a mixture of plasticisers which are not solid at room temperature. Said plasticisers further lower the melt viscosity of the molten adhesive compositions and increase their tackiness.

The plasticisers, which are not solid at room temperature and the mixtures of plasticisers which are not solid at room temperature, and that can be used in the hot-melt adhesives of the present invention, are selected, for example, from paraffinic mineral oils and naphthenic mineral oils and mixtures thereof; paraffinic and naphthenic hydrocarbons which are not solid at room temperature, and mixtures thereof; polyolefin oligomers which are not solid at room temperature, and copolymers thereof, such as oligomers derived from ethene, propene, butene, iso-butylene, copolymers thereof, and mixtures thereof; plasticizers which are not solid at room temperature formed by esters, such as phthalates, benzoates, sebacates, citrates; natural and synthetic fats; vegetable oils; and mixtures thereof.

Particularly preferred are mineral oils, both paraffinic and naphthenic ones, and their mixtures; and the oligomers of synthetic poly-alpha-olefins, not solid at room temperature, known with the acronym “PAO” (poly-alpha-olefins). Said synthetic oligomeric plasticisers, not solid at room temperature, that can be used in the present invention, are synthetised from olefins from C2 to C20 and have an average Number Molecular Weight Mn ranging from 150 g/mole to 15,000 g/mole, preferably from 200 g/mole to 10,000 g/mole and even more preferably from 400 g/mole to 6.000 g/mole. Said PAO plasticisers are fully saturated and can have a substantially paraffinic structure, both linear and branched. Synthetic poly-alpha-olefins, not solid at room temperature, usable as plasticisers in the present invention are manufactured and sold e.g. by ExxonMobil with the trade marks SpectraSyn and Elevast; by Ineos with the trade mark Durasyn, by Chevron Phillips with the trade mark Synfluid etc.

In the embodiment of the present invention where the herein disclosed hot-melt adhesive formulations comprise at least one plasticiser which is not solid at room temperature or a mixture of plasticisers which are not solid at room temperature, the adhesives disclosed herein comprise from zero to 50% by weight of said plasticiser or mixture of plasticisers, preferably from 5% by weight to 40% by weight and even more preferably from 10% by weight to 35% by weight, referred to the whole hot-melt adhesive formulation.

### Waxes

In an additional embodiment of the present invention, the present hot-melt adhesive formulations comprise also at least one wax or a mixture of waxes, natural or synthetic ones, which have a dropping point, measured according to the method ASTM D 3952-94, ranging from 40° C. and 170° C. Waxes that can be used in the present invention are for example, synthetic hydrocarbon waxes, such as paraffinic waxes, and especially waxes synthesised from olefins from C2 to C10 and their blends; hydrocarbon waxes from C12 to C40, even in their variants modified with carboxylic/acidic or with alcoholic groups; copolymer waxes synthesised from ethene and maleic anhydride or from propene and maleic anhydride; Fischer-Tropsch waxes; waxes formed by esters of fatty acids from C12 to C40; natural waxes like beeswax, carnauba wax, montan wax and the like; and mixtures thereof. In the embodiment of the present invention where the herein disclosed hot-melt adhesive formulations comprise at least one wax or a mixture of waxes, they comprise from zero to 20% by weight, preferably from zero to 10% by weight of said wax or mixture of waxes, referred to the whole hot-melt adhesive formulation.

### Other Additional Components

The hot-melt adhesive formulations according to the present invention can furthermore comprise from 0.01% by weight to 10% by weight of at least one stabiliser, such as anti-oxidants, anti-UV photo-stabilisers, and mixtures thereof.

Moreover, they can also further comprise up to a maximum of about 15% by weight of other optional additional components, such as mineral fillers, pigments, dyes, perfumes, surfactants, antistatic agents, and mixtures thereof.

### Other Measurement Methods

### Measurement Method for the Rheological Relaxation Time

The rheological Relaxation Time tᵣ of a polymer or of a polymeric composition/formulation, such as a hot-melt adhesive formulation, is herein defined, as already mentioned, as that characteristic time that is needed by said polymer or polymeric composition/formulation for dissipating (e.g. by internal molecular frictions and by heat) the energy received from an external force, in this way returning to its primitive equilibrium state.

For the purposes of the present invention, said rheological Relaxation Time tᵣ, expressed in seconds (s), is herein measured at the reference temperature of 150° C., for the already explained reasons, and according to the following method.

The hot-melt adhesive formulation under test is placed between two parallel plates, with a diameter of 25 mm, of a Rheometer Ares—G2 supplied by TA Instruments, equipped with an ECT oven for heating the sample, and with a cooling system suitable for rapid cooling. The material is heated up to 180° C. and melted. Then it is conditioned at this temperature for 300 s, applying during all this conditioning time a shear rate equal to 1 s(−1). This initial heating up to the temperature of 180° C. and the following conditioning at said temperature for 300 s, are aimed at deleting the possible memory of the “thermal history” of the sample, by bringing the material into its fully amorphous form, destroying all the crystals that may have formed during the previous thermal treatments. In this way every material undergoing the test has the same “thermal history” like all the other samples.

When the conditioning step ends, the material is analysed in a way that allows to measure its main and characteristic rheological Relaxation Time tᵣ at the reference temperature of 150° C. For this measurement method, like for all the parameters, equations and methods of Polymer Rheology used herein, and especially for the concept of the “Time-Temperature Superposition Principle” or TTS; for the Williams-Landel-Ferry (WLF) equation; for the concept of “Master Curve at a certain reference temperature” and for the drawing of such Master Curve for the tested material at the chosen reference temperature, reference is here made to the book by John D. Ferry “Viscoelastic properties of polymers” (3d ed.—1980). New York: Wiley and to the article by John D. Ferry and H. S. Myers “Viscoelastic properties of polymers” published in Journal of The Electrochemical Society, 2007, 108(7), 142C.

In any case, the measurement method for the rheological Relaxation Time is simpler than it can initially appear. The method used herein is also clearly explained in details e.g. in the article “Basic principles and good practices of rheology for polymers for teachers and beginners”, by H. Ramsi et alii, published in “Chemistry Teacher International” 2022; 4(4): pages 307-326. In few words, the tested material undergoes a series of “Frequency Sweeps” in a range of frequencies from 0.01 rad/s and 200 rad/s (i.e. from 1.6.EXP(−3) Hz a 31.83 Hz) and in a range of temperatures from 70° C. to 210° C., at intervals of 10° C. between the various sweeps. As taught by the above mentioned references, these experiments are made by applying in each test a “suitable” percent deformation, that changes with temperature and that is in any case such that every test is done within the area of linear viscoelasticity (LVE).

As it is widely known by every person with an average expertise in the rheology of polymeric systems, and as it is well explained in the above mentioned references, this series of rheological experiments is aimed at drawing the Master Curve for the material at the reference temperature of 150° C., a curve which in this case shows at this temperature the various rheological parameters of the material, in particular its Elastic Modulus G′ and its Viscous Modulus G″, as a function of the Frequency/Shear Rate of the applied stress, in an extremely wide range of frequencies, range that in the specific case goes from 1.EXP(−6) rad/s to 1,000 rad/s (i.e. from 1.6.EXP(−7) Hz to 159 Hz).

The subsequent analysis of the obtained Master Curve for G′ and G″ is focused on the terminal zone, i.e. the zone of the lowest frequencies and more specifically on the zone of frequencies where G″ becomes greater than G′. As well known, this zone of the curve is the one that relates to the “terminal relaxation” of the material; i.e. it is the zone of frequencies in which a viscoelastic material (like the adhesive polymeric formulations disclosed herein) is ideally behaving like a “Maxwell fluid”. In this zone, at the lowest frequencies, the curve that represents the Viscous Modulus G″ tends to an asymptotic value, with a slope equal to 1; while the curve that represents the Elastic Modulus G′ tends to another asymptotic value, with a slope equal to 2.

Therefore, by interpolating, with two straight lines, having said slopes, the experimental points of G″ and G′ it is possible to identify their crossing point. According to the teachings of the Theory of Polymers' Viscoelasticity, used herein, the frequency of that crossing point of the two rheological Moduli is the characteristic frequency at which the tested material is relaxing; and the inverse of that frequency gives directly the value of the main rheological Relaxation Time tᵣ for the polymeric material under test.

### Method for the Qualitative Assessment of the Die Build-Up Phenomenon

As already mentioned, the die build-up or die drool phenomenon, i.e. a chaotic accretion of extruded material on the extrusion die, is to be absolutely avoided, because it leads to highly negative consequences during the application process of the adhesives, as well as on the adhesive strength that is achievable and on the quality of the final products (gross unevenness of the coated adhesive layer; absence of the adhesive in various areas of the substrate; presence of big lumps of adhesive in other areas; fouling of the line etc.).

The presence or absence of the die build-up phenomenon for the hot-melt adhesives of the present invention is herein qualitatively assessed, operating under conditions which reproduce the typical operating conditions of the production lines of hygienic absorbent articles. In particular, the presence or absence of this phenomenon in the extrusion of the tested adhesives is assessed by coating a polypropylene nonwoven substrate, with a basis weight of 12 g/m², supplied by Union Industries (Italy).

On a pilot line, which reproduces the operating conditions of an industrial line for hygienic articles and that runs at the speed of 250 m/minute, the tested adhesive is extruded by slot-die at the temperature of 150° C. and coated on the mentioned nonwoven at a basis weight of 1.5 g/m². The presence at a significant level (or the absence) of the die build-up phenomenon is checked visually, by observing the possible accretion of extruded material nearby the extrusion die. This possible accretion of extruded material is easily visible as a layer of material that remains adhered on the outside metal of the extrusion die with a thickness of at least 2 to 5 mm (or more) and that is as wide as the width of the extrusion slot. Said layer of material, accumulated on the die and that continues to grow with time, now and then detaches from the die at irregular intervals of time, forming big lumps that are dragged away by the moving nonwoven, while the mass accretion restarts.

In the operating condition used herein, in the presence of the die build-up phenomenon, a visible accumulation of material on the die can be observed even just after about 10 to 15 seconds of extrusion, and in any case within 60 s. If on the contrary, no significant accumulation of extruded material is visible after at least 120 s of continuous running of the line, the conclusion is that the tested material does not exhibit any “die build-up” or “die drool” phenomenon.

### EXAMPLES

The present invention is better illustrated by the following examples, which are given herein merely for the purpose of illustration and are not to be regarded as limiting the scope of the invention or the manner in which it can be practiced. Unless specifically indicated otherwise, parts and percentages are given by weight.

### EXAMPLES ACCORDING TO THE INVENTION

### Example 1

The following hot-melt adhesive formulation according to the present invention has been prepared by mixing its components in the molten state at 170° C.

| Component | % by weight | Nature and Supplier |
|---|---|---|
| Vistamaxx | 17.5 | Metallocene C3-C2 copolymer |
| 6902 | | available from ExxonMobil |
| Regalite R | 72.0 | Hydrogenated hydrocarbon |
| 1100 | | tackifier available from |
| | | Synthomer (R&B = 100° C.) |
| Primol 352 | 8.7 | Plasticising paraffinic mineral |
| | | oil available from ExxonMobil |
| Irganox 1010 | 1.8 | Antioxidant available from BASF |

The hot-melt formulation of Example 1 comprises, as its only polymeric component, Vistamaxx 6902, which is a metallocene copolymer of propene with 12% by weight of ethene. It is believed to have a Weight Average Molecular Weight Mw of about 95,000 g/mole. In this example, the basic polymer has been plasticised with Primol 352, a paraffinic mineral oil with a Weight Average Molecular Weight Mw equal to 480 g/mole. Vistamaxx 6902 has been also tackified with Regalite R 1100, a hydrogenated hydrocarbon tackifying with a Ring & Ball softening point of 100° C.

The above hot-melt adhesive exhibits, at the reference temperature of 150° C., a rheological Relaxation Time tᵣ, measured according to the previously described method, equal to 2.29 ms, and a Brookfield viscosity at 150° C., equal to 4,410 mPa·s. It exhibits also a Brookfield viscosity at 170° C. equal to 1,950 mPa·s.

In fact, when it was tested for the possible presence of a “die build-up” phenomenon in slot-die extrusion, by processing it on a pilot line running at the very high speed of 250 m/minute and following all the conditions defined in the above method for visually assessing the possible presence in extrusion of build-up phenomena, this hot-melt adhesive did not exhibit any build-up at all even after 15 minutes of continuous line running. Owing also to this fully excellent processability, when tested also for its Peel Strength after five days of aging at 23° C., by following the previously explained method, the hot-melt adhesive of Example 1 showed the very good Peel value of 1.7 N/50 mm at the very low basis weight of just 1.5 g/m².

### Example 2

The following hot-melt adhesive formulation according to the present invention has been prepared by mixing its components in the molten state at 170° C.

| Component | % by weight | Nature and Supplier |
|---|---|---|
| Europrene | 18.8 | Styrenic block copolymer (SIS) |
| SOL T 9113 | | available from Versalis |
| Indopol H- | 24.2 | Poly-iso-butene liquid oligomer |
| 300 | | available from Ineos |
| Escorez 5400 | 56.0 | Hydrogenated cycloaliphatic |
| | | hydrocarbon tackifier available |
| | | from ExxonMobil (R&B = 104.3° C.) |
| Irganox 1010 | 1.0 | Antioxidant available from BASF |

Also, the hot-melt formulation of Example 2 comprises one polymer that, in this case, is plasticised with a liquid oligomer. More precisely, the polymer is the styrenic block copolymer Europrene SOL T 9113, which is a Styrene-Isoprene-Styrene block copolymer with a content of styrene of 18% b.w. and a Weight Average Molecular Weight Mw that is believed to be about 142,000 g/mole. In the same formulation, the plasticising oligomer is Indopol H-300, which is a liquid poly-iso-butene (PIB) oligomer with a Weight Average Molecular Weight Mw equal to 2,150 g/mole.

The adhesive formulation of Example 2 has been tackified with Escorez 5400, a hydrogenated cycloaliphatic hydrocarbon tackifying resin that has a Ring & Ball softening temperature of 104.3° C.

The hot-melt adhesive of Example 2 has a rheological Relaxation Time tᵣ, measured at 150° C. according to the previously described method, equal to 2.10 ms, and a Brookfield viscosity at 150° C., equal to 3,970 mPa·s. Its Brookfield viscosity at 170° C. is equal to 1,860 mPa·s.

When tested for a possible “die build-up” in slot-die extrusion, according to the previously explained method, this hot-melt adhesive did not exhibit any build-up at all even after 15 minutes of continuous line running. As said, this translates also into optimum adhesive properties, e.g. it gave a Peel Strength at the basis weight of 1.5 g/m², equal to 2.2 N/50 mm, when tested according the described method.

### Example 3

The following hot-melt adhesive formulation according to the present invention has been prepared by mixing its components in the molten state at 170° C.

| Component | % by weight | Nature and Supplier |
|---|---|---|
| Vistamaxx | 24.0 | Metallocene C3-C2 copolymer |
| 8380 | | available from ExxonMobil |
| Vistamaxx | 12.0 | Metallocene C3-C2 copolymer |
| 6902 | | available from ExxonMobil |
| Vistamaxx | 4.0 | Metallocene C3-C2 copolymer |
| 6502 | | available from ExxonMobil |
| Regalite R | 51.0 | Hydrogenated hydrocarbon |
| 1100 | | tackifier available from |
| | | Synthomer (R&B = 100° C.) |
| Primol 352 | 7.5 | Plasticising paraffinic mineral |
| | | oil available from ExxonMobil |
| Irganox 1010 | 1.5 | Antioxidant available from BASF |

The adhesive formulation of Example 3 comprises a mixture of three polymers which are all metallocene semi-crystalline copolymers of propene with minor amounts of ethene. The first polymer is Vistamaxx 6902, that was already comprised in Example 1 (C2=12% by weight; Mw=95,000 g/mole). The other two polymers are Vistamaxx 8380 which is also a C3-C2 copolymer with a C2 content of 12% by weight and that is believed to have a Weight Average Molecular Weight Mw equal to about 43,000 g/mole; and Vistamaxx 6502 that has a C2 content of 13% by weight and that is believed to have a Weight Average Molecular Weight Mw equal to about 115,000 g/mole.

The mixture of polymers is tackified with Regalite R 1100, a hydrogenated hydrocarbon tackifier with a Ring & Ball softening temperature of 100° C.); and it is also plasticised with the paraffinic mineral oil Primol 352.

When tested for its rheological Relaxation Time at 150° C., the adhesive formulation of this Example 3, according to the present invention, exhibits a tᵣ equal to 0.91 ms. At the same temperature of 150° C., this hot-melt adhesive has a Brookfield viscosity of 6,600 mPa·s. Its Brookfield viscosity at 170° C. is equal to 3,240 mPa·s.

With such properties, the hot-melt adhesive of the present Example 3 can be processed by extrusion in slot-die coating, even at the line speed of 250 in/minute without showing any trace of die build-up, even after 15 minutes of continuous running of the line. This excellent processability is indirectly confirmed also by the strong value of the adhesive Peel Strength achieved by this formulation, peel strength that, when tested according to the above described method, reaches the value of 2.1 N/50 mm at the very low basis weight of just 1.5 g/m².

### Example 4

The following hot-melt adhesive formulation according to the present invention has been prepared by mixing its components in the molten state at 170° C.

| Component | % by weight | Nature and Supplier |
|---|---|---|
| Koattro PB | 25.3 | Isotactic metallocene butene-1 |
| M 1500M | | copolymer available from |
| | | LyondellBasell |
| Koattro PB | 11.6 | Isotactic metallocene butene-1 |
| M 8911M | | copolymer available from |
| | | LyondellBasell |
| Koattro PB | 4.1 | Isotactic metallocene butene-1 |
| M 8510M | | copolymer available from |
| | | LyondellBasell |
| Regalite R | 53.2 | Hydrogenated hydrocarbon |
| 1100 | | tackifier available from |
| | | Synthomer. |
| Primol 352 | 3.8 | Paraffinic mineral oil available from |
| | | ExxonMobil |
| Irganox | 2.0 | Antioxidant available from BASF |
| 1010 | | |

Also the hot-melt adhesive formulation disclosed in Example 4 comprises a mixture of three polymers as the previous Example 3. However in the present case the comprised polymers are all metallocene semi-crystalline copolymers of butene-1, with minor amounts of ethene. More specifically: Koattro PB M 1500M is supposed to contain about 6.0% by weight ethene and to have a Weight Average Molecular Weight Mw of about 45,000 g/mole; Koattro PB M 8911M is supposed to contain about 4.0% by weight ethene and to have a Weight Average Molecular Weight Mw of about 93,000 g/mole; and Koattro PB M 8510M is supposed to have a C2 content of also about 4.0 by weight and a Weight Average Molecular Weight Mw of about 130,000 g/mole. Also this mixture of polymers is tackified with Regalite R 1100 and is plasticised with the paraffinic mineral oil Primol 352.

Tested for its rheological Relaxation Time at 150° C., the formulation of Example 4 shows a Relaxation Time equal to 0.69 ms. At the same temperature of 150° C. this formulation has a Brookfield viscosity of 6,380 mPa·s. Its Brookfield viscosity at 170° C. is equal to 3,060 mPa·s.

This hot-melt formulation of Example 4 can be extruded by slot-die coating even at high line speed, like 250 m/minute, with no trace at all of any die build-up even after 15 minutes of line running.

Owing also to its very regular processability in die-coating, this hot-melt formulation exhibits an excellent adhesive behaviour, with a Peel Strength of 1.7 N/50 mm, even at the low basis weight of 1.5 g/m².

### Example 5

The following hot-melt adhesive formulation according to the present invention has been prepared, by mixing its components in the molten state at 170° C.

| Component | % by weight | Nature and Supplier |
|---|---|---|
| Vistamaxx | 10.0 | Metallocene C3-C2 copolymer |
| 6902 | | available from ExxonMobil |
| Vistamaxx | 5.0 | Metallocene C3-C2 copolymer |
| 6502 | | available from ExxonMobil |
| Licocene PP | 17.5 | Metallocene C3-C2 copolymer |
| 1302 | | available from Clariant |
| Licocene PP | 17.5 | Metallocene C3-C2 copolymer |
| 3602 | | available from Clariant |
| Licocene PPA | 10.0 | Metallocene C3-C2 semi-fluid |
| 330 | | oligomer available from Clariant |
| Eastotac H- | 38.5 | Hydrogenated aliphatic |
| 100L | | hydrocarbon tackifier available |
| | | from Synthomer |
| Irganox 1010 | 1.5 | Antioxidant available from BASF |

The hot-melt adhesive formulation disclosed in Example 5 comprises a mixture of as many as four metallocene polymers, said mixture being also plasticized with a semi-fluid metallocene oligomer of propene and ethene. This oligomer, which is not solid at room temperature, is Licocene PPA 330, that is supposed to contain about 20.5% ethene and to have a Weight Average Molecular Weight Mw of about 6,400 g/mole.

The four polymers in Example 5 are first of all Vistamaxx 6902 and Vistamaxx 6502, that have been already described in the previous Examples. In addition, the hot-melt adhesive formulation of the present Example 5 comprises also Licocene PP 1302 and Licocene PP 3602 that are both metallocenic copolymers of propene with minor amounts of ethene. More precisely Licocene 1302 is a C3-C2 copolymer which is supposed to have a Weight Average Molecular Weight Mw of about 17,300 g/mole and a C2 content of about 10% by weight; while Licocene 3602 is believed to have a Weight Average Molecular Weight Mw of about 45,100 g/mole and a C2 content of about 8% by weight.

The above hot-melt adhesive exhibits, at the reference temperature of 150° C., a rheological Relaxation Time tᵣ, measured according to the previously described method, equal to 1.24 ms, and a Brookfield viscosity at 150° C., equal to 7,860 mPa·s. Said hot-melt formulation has also a Brookfield viscosity at 170° C. equal to 4,120 mPa·s.

This formulation can be processed without any problem of die build-up even after 15 minutes of continuous extrusion on a line running at 250 m/minute; and when tested for its adhesive properties, it shows an optimum Peel Strength as high as 2.6 N/50 mm, at the very low adhesive basis weight of 1.5 g/m².

### COMPARATIVE EXAMPLES

### Comparative Example 1

The following comparative hot-melt adhesive formulation has been prepared by mixing its components in the molten state at 170° C.

| Component | % by weight | Nature and Supplier |
|---|---|---|
| Vistamaxx | 43.2 | Metallocene C3-C2 copolymer |
| 8380 | | available from ExxonMobil |
| Regalite R | 46.3 | Hydrogenated hydrocarbon |
| 1100 | | tackifier available from |
| | | Synthomer (R&B = 100° C.) |
| Primol 352 | 8.7 | Plasticising paraffinic mineral |
| | | oil available from ExxonMobil |
| Irganox 1010 | 1.8 | Antioxidant available from BASF |

The hot-melt formulation of Comparative Example 1 is analogous to the previous Example 1 according to the invention. The main difference is that this comparative example comprises, as its only polymeric component, Vistamaxx 8380, that has been already described in the previous Example 3 according to the invention, as a substitute for Vistamaxx 6902.

The above comparative hot-melt adhesive shows, at the reference temperature of 150° C., a too low rheological Relaxation Time tᵣ, measured according to the previously described method, being equal just to 0.15 ms; and it has a Brookfield viscosity at 150° C., equal to 2,900 mPa·s. Its Brookfield viscosity at 170° C. is equal to 1,530 mPa·s.

As expected, based on the above too low value of tᵣ, the hot-melt adhesive formulation of the Comparative Example 1 is processed very badly in extrusion. In fact, when it is tested according to the previously described method for the qualitative assessment of the build-up phenomenon, this hot-melt exhibits a massive die build-up that is very evident just after less than 20 seconds of line running.

This very bad processing in extrusion is translated also in poor adhesive properties due to the strong unevenness and inhomogeneity of the extruded adhesive coating. In fact, the Peel Strength achieved with this formulation, at the basis weight of 1.5 g/m², is only 0.55 N/50 mm.

### Comparative Example 2

The following comparative hot-melt adhesive formulation has been prepared by mixing its components in the molten state at 170° C.

| Component | % by weight | Nature and Supplier |
|---|---|---|
| Licocene PP | 50.0 | Metallocene C3-C2 copolymer |
| 1302 | | available from Clariant |
| Licocene PP | 40.0 | Metallocene C3-C2 copolymer |
| 3602 | | available from Clariant |
| Vistamaxx | 10.0 | Metallocene C3-C2 copolymer |
| 6502 | | available from ExxonMobil |

The hot-melt adhesive formulation disclosed in Comparative Example 2 has been prepared by following the teachings of a prior patent. The results of the behaviour in extrusion of this hot-melt formulation have been very negative because, in the above described test for the assessment of build-up phenomena, this adhesive shows the presence of a massive die build-up that appears very visibly even just a few seconds after the starting of the extrusion. The presence of such massive build-up is related to the fact that the present formulation of Comparative Example 2, has a too low rheological Relaxation Time tᵣ, at the reference temperature of 150° C. Indeed, from the previously described test for such parameter, its rheological Relaxation Time at 150° C. is just 0.28 ms. At the same reference temperature of 150° C., the above formulation exhibits a Brookfield viscosity equal to 6,130 mPa·s; while at 170° C. its Brookfield viscosity is 3500 mPa·s,

### Comparative Example 3

The following comparative hot-melt adhesive formulation has been prepared by mixing its components in the molten state at 170° C.

| Component | % by weight | Nature and Supplier |
|---|---|---|
| Licocene PP | 25.3 | Metallocene C3-C2 copolymer |
| 1602 | | available from Clariant |
| Licocene PP | 12.7 | Metallocene C3-C2 copolymer |
| 3602 | | available from Clariant |
| Licocene PPA | 17.0 | Metallocene C3-C2 semi-fluid |
| 330 | | oligomer available from Clariant |
| Vistamaxx | 5.0 | Metallocene C3-C2 copolymer |
| 6502 | | available from ExxonMobil |
| Eastotac H- | 40.0 | Hydrogenated aliphatic |
| 100L | | hydrocarbon tackifier available |
| | | from Synthomer |

Like for the precedent example, also the hot-melt adhesive shown in Comparative Example 3 has been prepared by following the teachings of a prior patent. In this formulation Licocene 1602 is a metallocene C3-C2 copolymer which is supposed to have a Weight Average Molecular Weight Mw of about 25,900 g/mole and a C2 content of about 10% by weight.

Also in this case the behaviour in extrusion of the above hot-melt has been negative, with an apparent die build-up that has appeared in considerable amount in less than 30 seconds from the starting of the extrusion test. Actually, when tested for its rheological Relaxation Time tᵣ, at the reference temperature of 150° C., the present adhesive formulation shows the quite low value tᵣ=0.24 ms,

At the same reference temperature of 150° C., the hot-melt formulation of Comparative Example 3 has a Brookfield viscosity equal to 4,610 mPa·s; while at 170° C. the Brookfield viscosity is 2,440 mPa·s.

### Comparative Example 4

The following comparative hot-melt adhesive formulation has been prepared by mixing its components in the molten state at 170° C.

| Component | % by weight | Nature and Supplier |
|---|---|---|
| Vistamaxx | 14.7 | Metallocene C3-C2 copolymer |
| 8380 | | available from ExxonMobil |
| Vistamaxx | 25.7 | Metallocene C3-C2 copolymer |
| 8880 | | available from ExxonMobil |
| Vistamaxx | 9.6 | Metallocene C3-C2 copolymer |
| 6502 | | available from ExxonMobil |
| Regalite R | 41.0 | Hydrogenated hydrocarbon |
| 1100 | | tackifier available from |
| | | Synthomer (R&B = 100° C.) |
| Primol 352 | 7.5 | Plasticizing paraffinic mineral |
| | | oil available from ExxonMobil |
| Irganox 1010 | 1.5 | Antioxidant available from BASF |

The hot-melt formulation of Comparative Example 4 is similar to the adhesive formulation shown in the previous Example 3 according to the present invention. The main difference is the fact that in this comparative example Vistamaxx 6902 has been substituted by Vistamaxx 8880 which is a C3-C2 copolymer with a C2 content of 12% by weight and which is believed to have a Weight Average Molecular Weight Mw equal to about 27,600 g/mole.

However, such combination of Vistamaxx copolymers exhibits a very short rheological Relaxation Time tᵣ, at the reference temperature of 150° C., which is as low as just 0.14 ms. In fact, the present comparative hot-melt is processed very bad in slot-die extrusion giving a massive phenomenon of die-build up that is clearly visible just a few seconds after the starting of the test for assessing the presence of such phenomenon.

The present comparative formulation has a Brookfield viscosity at 150° C. and at 170° V, which are respectively 5,600 mPa·s and 2,970 mPa·s.

1) A hot melt adhesive formulation comprising a polymer or a compatible mixture of two or more polymers, said hot melt adhesive formulation further comprising:
a rheological Relaxation Time tᵣ not lower than 0.5 ms, as measured at 150° C. according to the herein described method;
a Brookfield viscosity at 150° C. ranging from 500 mPa·s to 150,000 mPa·s.

2) A hot melt adhesive formulation according to claim 1, wherein the polymer or the compatible mixture of polymers constitutes from 5% to 100% by weight of said hot melt adhesive formulation.

3) A hot melt adhesive formulation according to claim 1, wherein the polymer consists of a homopolymer of C2 to C12 olefins or of a copolymer of the homopolymer; or wherein the compatible mixture of polymers consists of homopolymers or copolymers of C2 to C12 olefins.

4) A hot melt adhesive formulation according to claim 1, wherein the polymer consists of an elastomeric styrenic block copolymer or of a mixture of at least two elastomeric styrenic block copolymers.

5) A hot melt adhesive formulation according to claim 4, wherein the elastomeric blocks of the styrenic elastomeric block copolymer(s) are selected from the group consisting of poly(butadiene), poly(isoprene), poly(butadiene-isoprene), poly(ethene-butylene) and poly(ethene-propene).

6) A hot melt adhesive formulation according to claim 1, which comprises at least one tackifying resin or a mixture of tackifying resins having a Ring & Ball softening temperature ranging from 5° C. to 160° C.

7) A hot melt adhesive formulation according to claim 6, wherein the tackifying resin or the mixture of tackifying resins is selected from the group consisting of aliphatic hydrocarbon resins and their partially or totally hydrogenated derivatives; aromatic hydrocarbon resins and their partially or totally hydrogenated derivatives; aliphatic-aromatic hydrocarbon resins and their partially or totally hydrogenated derivatives; polyterpene resins and modified terpene resins and their partially or totally hydrogenated derivatives; rosins (colophonies), their esters and their partially or totally hydrogenated derivatives; and mixtures thereof.

8) A hot melt adhesive formulation according to claim 6, wherein the tackifying resin or the mixture of tackifying resins has a Ring & Ball softening temperature ranging from 50° C. to 155° C.

9) A hot melt adhesive formulation according to claim 6, wherein the tackifying resin or the mixture of tackifying resins has a content of volatile impurities not higher than 5 ppm.

10) A hot melt adhesive formulation according to claim 6, wherein the tackifying resin or the mixture of tackifying resins is from zero to 75% by weight of the adhesive formulation.

11) A hot melt adhesive formulation according to claim 1, which comprises at least one plasticiser, that is not solid at room temperature, or a mixture of plasticisers that are not solid at room temperature.

12) A thot melt adhesive formulation according to claim 11, wherein the plasticiser that is not solid at room temperature, or the mixture of plasticisers that are not solid at room temperature, is selected from the group consisting of paraffinic mineral oils and naphthenic mineral oils and mixtures thereof; paraffinic and naphthenic hydrocarbons that are not solid at room temperature, and mixtures thereof; polyolefin oligomers that are not solid at room temperature, and copolymers thereof, oligomers derived from ethene, propene, butene, iso-butylene, copolymers thereof, and mixtures thereof; plasticisers that are not solid at room temperature formed by esters, phthalates, benzoates, sebacates, citrates; natural and synthetic fats; vegetable oils; and mixtures thereof.

13) A hot melt adhesive formulation according to claim 11, wherein the plasticiser that is not solid at room temperature, or the mixture of plasticisers that are not solid at room temperature, consists of an oligomer or of a mixture of synthetic poly-alpha-olefin oligomers, synthesised from C2 to C20 olefins, and having a number average molecular weight Mn ranging from 150 g/mole to 15,000 g/mol.

14) A hot melt adhesive formulation according to claim 11, wherein the plasticiser that is not solid at room temperature, or the mixture of plasticizers that are not solid at room temperature, is from 0 to 50% by weight of the adhesive formulation.

15) A hot melt adhesive formulation according to claim 1, which comprises at least one wax, or a mixture of waxes, having a dropping point ranging from 40° C. to 170° C., as measured according to the ASTM D-3954-94 method.

16) A hot melt adhesive formulation according to claim 15, wherein the wax or the mixture of waxes is selected from the group consisting of paraffinic waxes, waxes synthesised from C2 to C12 olefins, and mixtures thereof; C12 to C40 hydrocarbon waxes and their variants modified with acidic carboxylic or alcoholic groups; copolymer waxes synthesised from ethene and maleic anhydride or from propene and maleic anhydride; Fischer-Tropsch waxes; microcrystalline waxes; waxes formed by esters of C12 to C40 fatty acids; natural waxes, beeswax, carnauba wax, montan wax and the like; and mixtures thereof.

17) A hot melt adhesive formulation according to claim 15, wherein the wax or the mixture of waxes is from 0 to 20% by weight of the adhesive formulation.

18) A hot melt adhesive formulation according to claim 1 which, subjected to a DSC melting test, after aging for five days under room conditions, exhibits an Enthalpy of fusion not greater than 50 J/g.

19) A hot melt adhesive formulation according to claim 1, which exhibits a Brookfield viscosity at 170° C. ranging from 500 mPa·s to 150,000 mPa·s.

20) A hot melt adhesive formulation according to claim 1, which exhibits, after aging for five days under room conditions, a Stress-Elongation at Break curve, as measured at 23° C. and a frequency of 0.01 Hz, with a yield stress not lower than 0.001 MPa.

21) A hot melt adhesive formulation according to claim 1, which exhibits, after aging for five days under room conditions, a Stress-Elongation at Break curve, as measured at 23° C. and a frequency of 0.01 Hz, with an elongation at break not lower than 50%.

22) A hot melt adhesive formulation according to claim 1 which exhibits, after aging for five days under room conditions, a Stress-Elongation at Break curve, as measured at 23° C. and a frequency of 0.01 Hz, with a toughness not lower than 0.2 MJ/m³.

23) A hot melt adhesive formulation according to claim 1 which exhibits a Zero Shear Viscosity at 150° C. not lower than 4,000 mPa·s, as measured according to the herein described method.

24) A bonded structure comprising:
a first substrate;
a second substrate;
a hot melt adhesive formulation according to claim 1, bonding the first substrate to the second substrate, which, when applied at a basis weight ranging from 0.5 g/m² to 50 g/m², gives the bonded structure a Peel Strength greater than 0.25 N per 50 mm of width.

25) A hygienic absorbent article comprising the hot melt adhesive formulation according to claim 1.

26) A hygienic absorbent article comprising a bonded structure according to claim 24.

27) A hygienic absorbent article according to claim 25, wherein said article is an absorbent baby diaper, an absorbent training diaper for children's first steps, an absorbent diaper for incontinent adults, or an absorbent article for feminine hygiene.

28) A hygienic absorbent article according to claim 25, wherein the hot melt adhesive formulation is used for at least one of the following uses: i) general adhesive for the construction of the whole article; ii) for bonding elastic components; iii) for consolidating and ensuring also in use the integrity of the absorbent layers of the absorbent sanitary article; iv) for bonding perforated films which have either a bidimensional or a tridimensional structure.

29) An article comprising the hot melt adhesive formulation according to claim 1, wherein said article is an absorbent mattress, or sheet, or surgical laminate for medical use, or a product for covering and protecting wounds.

30) An article comprising the hot-melt adhesive formulation according to claim 1, wherein said article is a mattress, or a component thereof.

31) An article comprising the hot-melt adhesive composition according to claim 1, wherein said article is a packaging.

32) An article according to claim 25, wherein the hot-melt adhesive formulation is applied by a slot-die extrusion process in at least one of its uses inside that article.
